(19) United States
(12) Patent Application Publication
(10) Pub. No.: US 2015/0354393 A1
(43) Pub. Date: Dec. 10, 2015

(54) METHODS OF MANUFACTURING A SHROUD ABRADABLE COATING

(71) Applicant: GENERAL ELECTRIC COMPANY, Schenectady, NY (US)

(72) Inventors: Don Mark LIPKIN, Niskayuna, NY (US); Luc Stephane LEBLANC, Clifton Park, NY (US); Joshua Lee MARGOLIES, Niskayuna, NY (US); Nicholas Edward ANTOLINO, Schenectady, NY (US)

(73) Assignee: GENERAL ELECTRIC COMPANY, Schenectady, NY (US)

(21) Appl. No.: 14/300,666

(22) Filed: Jun. 10, 2014

(51) Int. Cl. F01D 11/12; C23C 4/00

(52) U.S. Cl. CPC F01D 11/122; C23C 4/005; F05D 2230/31; F05D 2300/608; F05D 2300/211; F05D 2300/2118; F05D 2230/22; F05D 2240/11

(57) ABSTRACT

Methods of manufacturing turbine shrouds with an abradable coating that balance the apparently contradictory requirements of high flowpath solidity, low blade tip wear, and good durability in service. The methods include obtaining a shroud substrate. The methods may include obtaining a coating system on the shroud substrate. The methods include forming an abradable coating on a surface of the coating system so as to form a substantially smooth flowpath surface. Forming the abradable coating includes forming a relatively dense scaffold and relatively porous filler regions in-between the relatively dense abradable scaffold. The methods may also include machining the abradable so as to achieve a substantially smooth flowpath surface comprising a relatively porous abradable phase surrounded by a relatively dense, high-durability corrale phase.

### BACKGROUND

The present disclosure generally relates to methods of manufacturing high temperature abradable coatings, and in particular to methods of manufacturing turbine shrouds with high temperature abradable coatings.

Materials which abrade relatively readily may be used to form seals between a rotating component (rotor) and a fixed component (stator). Typically, the rotor wears away a portion of a stator having the abradable material, so as to form a seal characterized by a relatively small gap between the rotor and stator. An important application of abradable seals is in turbines (e.g., gas turbines), in which a rotor including a plurality of blades mounted on a shaft is surrounded by a stationary shroud. In the high pressure turbine (HPT) section, these shrouds, referred to as HPT shrouds, define a hot gas flowpath in the turbine. Minimizing the clearance between the blade tips and the inner wall of the shroud reduces leakage of the hot gas around the blade tips, leading to improved turbine efficiency.

To reduce blade tip wear, it is known in the art to use patterned abradable architectures on the shroud flowpath surface. By reducing the solidity of the shroud surface in contact with the passing blade, the relative blade tip wear is significantly reduced. While a patterned shroud surface may reduce blade wear, it can significantly decrease turbine efficiency due to leakage losses over the passing blade tips. As a result, substantially smooth, continuous-flowpath surface abradable structures are desired to reduce leakage, while patterned abradable surfaces are desired to minimize blade tip wear. One approach to resolve this apparent contradiction of shroud flowpath surfaces has been to use highly porous abradable materials with a substantially smooth, continuous flowpath surface. However, such materials are found to be highly friable, suffering low durability under erosive and other harsh-environment conditions.

As a result, a need exists for methods of making abradable shrouds and resulting abradable shrouds that include an architecture and microstructure that balances the contradictory requirements of high flowpath solidity, low blade tip wear, and good durability in service.

### BRIEF DESCRIPTION

In one aspect, the present discourse provides a method of manufacturing a turbine shroud abradable coating. The method includes forming a relatively dense scaffold on a shroud substrate. The method further includes forming relatively porous filler regions in-between the relatively dense scaffold to form a substantially continuous flowpath surface.

In another aspect, the present discourse provides a method of manufacturing a turbine shroud abradable coating. The method includes forming a relatively porous pattern on a shroud substrate. The method further includes forming a relatively dense scaffold in-between the relatively porous pattern to form a substantially continuous flowpath surface.

In another aspect, the present discourse provides a method of manufacturing a turbine shroud abradable coating. The method includes forming a substantially continuous layer of relatively porous material on a shroud substrate. The method further includes selectively densifying portions of the substantially continuous layer of relatively porous material to form relatively dense scaffold regions within the relatively porous layer. The relatively porous regions and relatively dense regions form a substantially continuous flowpath surface.

In another aspect, the present discourse provides a method of manufacturing a turbine shroud abradable coating. The method includes thermally spraying an abradable material through a patterned mask onto a shroud substrate to substantially concurrently form: a relatively dense abradable scaffold; and relatively porous filler regions in-between the relatively dense scaffold. The scaffold and filler regions form a substantially continuous flowpath surface.

These and other objects, features and advantages of this disclosure will become apparent from the following detailed description of the various aspects of the disclosure taken in conjunction with the accompanying drawings.

### DRAWINGS

FIG. 1 is a top view of an exemplary embodiment of a shroud having an abradable coating according to the present disclosure, showing a trace of passing turbine blades;

FIG. 2 is a cross-sectional view of a portion of an exemplary shroud according to the present disclosure;

FIG. 3 is a flowchart depicting an exemplary method of manufacturing an exemplary shroud with an abradable coating according to the present disclosure;

FIG. 4 is a flowchart depicting an exemplary method of manufacturing an exemplary shroud with an abradable coating according to the present disclosure;

FIG. 5 is a flowchart depicting an exemplary method of manufacturing an exemplary shroud with an abradable coating according to the present disclosure; and

FIG. 6 is a flowchart depicting an exemplary method of manufacturing an exemplary shroud with an abradable coating according to the present disclosure.

### DETAILED DESCRIPTION

Each embodiment presented below facilitates the explanation of certain aspects of the disclosure, and should not be interpreted as limiting the scope of the disclosure. Moreover, approximating language, as used herein throughout the specification and claims, may be applied to modify any quantitative representation that could permissibly vary without resulting in a change in the basic function to which it is related. Accordingly, a value modified by a term or terms, such as “about,” is not limited to the precise value specified. In some instances, the approximating language may correspond to the precision of an instrument for measuring the value. When introducing elements of various embodiments, the articles “a,” “an,” “the,” and “said” are intended to mean that there are one or more of the elements. The terms “comprising,” “including,” and “having” are intended to be inclusive and mean that there may be additional elements other than the listed elements. As used herein, the terms “may” and “may be” indicate a possibility of an occurrence within a set of circumstances; a possession of a specified property, characteristic or function; and/or qualify another verb by expressing one or more of an ability, capability, or possibility associated with the qualified verb. Accordingly, usage of “may” and “may be” indicates that a modified term is apparently appropriate, capable, or suitable for an indicated capacity, function, or usage, while taking into account that in some circumstances, the modified term may sometimes not be appropriate, capable, or suitable. Any examples of operating parameters are not exclusive of other parameters of the disclosed embodiments. Components, aspects, features, configurations, arrangements, uses and the like described, illustrated or otherwise disclosed herein with respect to any particular embodiment may similarly be applied to any other embodiment disclosed herein.

As discussed above, conventional turbine shrouds include either a patterned surface or a substantially smooth surface configured to abrade when/if a turbine blade contacts the shroud. A substantially smooth abradable surface of a shroud maintains flowpath solidity but can result in severe blade tip wear. Patterned abradable shroud surfaces result in significantly reduced blade tip wear as compared to unpatterned or substantially smooth-flowpath shrouds, but allow leakage across the blade tip that leads to decreased turbine efficiency. The present disclosure provides shroud coatings, coated shrouds and methods of coating shrouds that include a hybrid architecture that balances the apparently contradictory requirements of high flowpath solidity, low blade tip wear, and high durability.

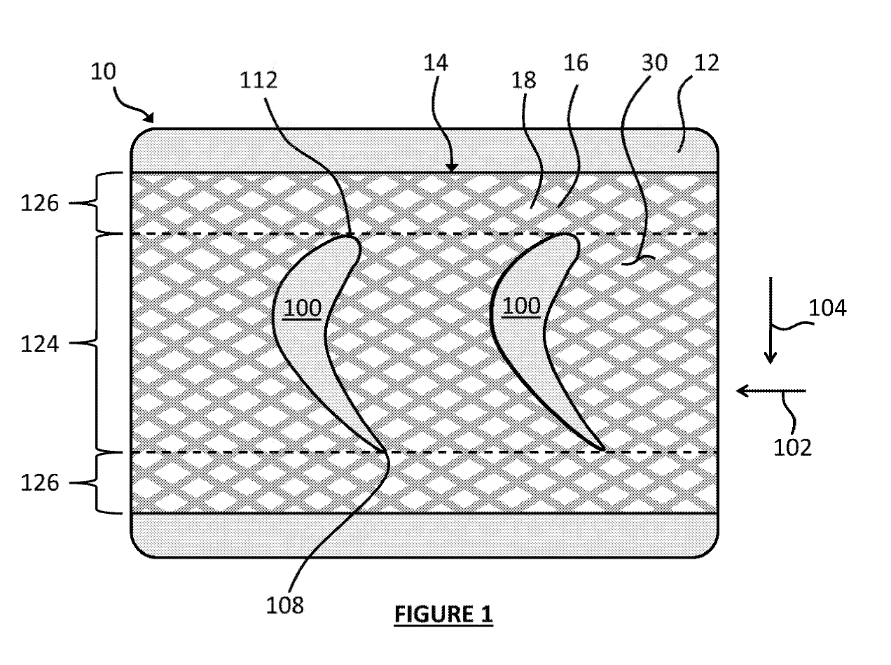

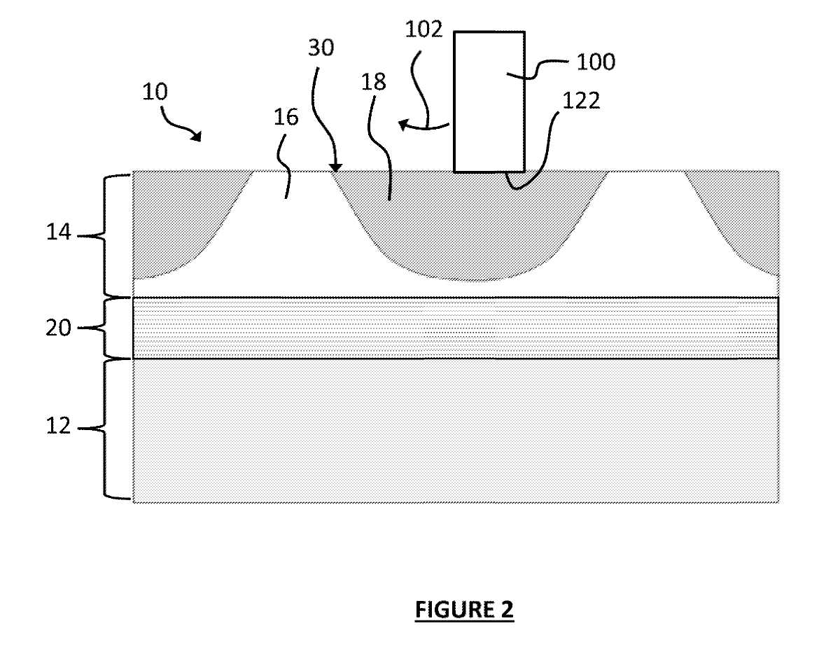

As shown in FIG. 1, an exemplary abradable coated shroud structure 10 according to the present disclosure may include a substrate 12 and an abradable coating 14 having a hybrid architecture and overlying a portion of the substrate 12. In some embodiments, the abradable coating 14 may overlie at least a portion of an inward-facing surface of the shroud 10 that, in use, is positioned adjacent the tips 122 of turbine blades 100, as shown in FIG. 2. As shown in FIG. 1, the shroud 10 may define, at least in part, the surface 30 of the hot gas flowpath through a particular portion of a turbine (i.e., the outer annulus of the turbine flowpath). To minimize leakage across the blade tips 122 (and therefore to maximize efficiency of the turbine), the shroud 10 and blade tips 122 may be configured such that the blade tips 122 rub into the abradable coating 14 during turbine operation. The architecture of the abradable coating 14 is configured to wear during blade incursion such that a seal is created between the blade tips 122 and the abradable coating 14 of the shroud 10. The architecture of the abradable coating 14 of the shroud 10 is configured to form a substantially smooth flowpath surface 30, minimize blade wear during incursions, and provide a thermo-mechanically durable flowpath surface 30 during use in a turbine.

With reference to FIG. 2, the substrate 12 of the abradable-coated shroud structure 10 may include or be formed of at least a first material. In some exemplary embodiments, the substrate 12 of the shroud 10 may be metallic. In some embodiments, the metallic base structure may be nickel-based and/or cobalt-based, such as a nickel-based or cobalt-based superalloy. In some other exemplary embodiments, the substrate 12 of the shroud 10 may be a ceramic, such as a ceramic matrix composite (CMC) material. In some such embodiments, the ceramic and/or CMC substrate 12 may be a SiC/SiC composite and/or an oxide/oxide composite. As shown in FIG. 2, the substrate 12 may form an inner base upon which other components or materials may be applied or affixed to form the shroud structure 10. In some embodiments, the substrate 12 may at least generally form the shape and size of the shroud structure 10. In some embodiments, the substrate 12 may substantially provide the structural support of the shroud structure 10.

In some embodiments the shroud 10 may include a coating system 20 disposed over the substrate 12. The coating system may comprise one or more component or material and may be positioned between the substrate 12 and the abradable coating 14. In some embodiments, the coating system 20 of the shroud 10 may include a bondcoat, a barrier coating, or a bondocat and a barrier coating. For example, in some embodiments the substrate 12 may be metal, and the coating system 20 of the shroud 10 may include a thermal barrier coating (TBC) applied thereon. In some such embodiments, the TBC-based coating system 20 of the TBC-coated metal substrate 12 may contain one or more TBC layers. The one or more TBC layers may be zirconia-based. In some embodiments, the one or more TBC layers of the coating system 20 may include yttria-stabilized zirconia (YSZ), such as zirconia containing 7-8 weight percent yttria. In some embodiments, the one or more TBC layers of the coating system 20 may include fully stabilized zirconia (FSZ).

As another example, in some embodiments the substrate 12 may be a ceramic, and the coating system 20 of the shroud 10 may include an environmental barrier coating (EBC) applied thereon. In some such embodiments, the EBC-based coating system 20 of the substrate 12 of the shroud 10 may contain one or more EBC layers. The one or more EBC layers of the coating system 20 may be silicate-based. In some embodiments, the one or more EBC layers of the coating system 20 may include one or more rare earth silicates, such as RE2Si2O7 and/or RE2SiO5, where RE comprises one or more of Y, Er, Yb, and Lu.

In some exemplary shroud embodiments 10, the coating system 20 may include a bondcoat overlying the substrate 12. In some embodiments, the coating system 20 may include an EBC or TBC coating applied over the bond coat. In some such embodiments, the bond coat of the coating system 20 may serve to provide oxidation resistance to the substrate 12 and/or to assist in maintaining adherence of the EBC/TBC coating. In some embodiments, the shroud 10 may include a TBC-coated metallic substrate 12, and the coating system 20 may include a bond coat between the substrate 12 and the TBC coating including a NiAl, (Pt,Ni)Al, or (Ni,Co)CrAlY type of composition. As another example, in some embodiments the shroud 10 may include an EBC-coated ceramic substrate 12, and the coating system 20 may include a Si-based bond coat between the substrate 12 and the EBC coating.

As shown in FIGS. 1 and 2 an as discussed above, the shroud 10 may include an exemplary abradable coating 14 overlying at least a portion of the shroud 10, such as over an outer surface of a coating system 20 on the shroud 10 (e.g., an EBC/TBC-based coating system 20). In some embodiments, the abradable coating 14 may define the flowpath surface 30 of the shroud 10 such that the flowpath surface 30 faces the centerline of a turbine when the shroud 10 and rotor are assembled. For example, as shown in FIGS. 1 and 2, the abradable coating 14 may form the flowpath surface 30 of the shroud 10 such that it faces or is directed toward, at least generally, rotating turbine blades 100 having tips 122 passing across the flowpath surface 30 of the shroud 10. As shown in FIGS. 1 and 2, in some embodiments the blades 100 may abrade, wear, or otherwise remove portions of the abradable coating 14 along a blade track 124 as the turbine blades 100 pass over (and through) the abradable coating 14 provided on shroud 10. Incursion of the turbine blade tips 122 within the abradable coating 14 may form wear track 124 within the abradable coating 14 during contact therewith, as shown in FIG. 1. Arrow 102 in FIG. 1 indicates a direction of translation of the turbine blade 100 with respect to the abradable coating 14 as results from a rotation of the turbine rotor, as described above. Arrow 104 in FIG. 1 indicates the axial direction of a fluid flow with respect to the abradable coating 14 and blades 100. The turbine blade tips 122 may include a leading edge 112 and a trailing edge 108, and the leading edge 112 and a trailing edge 108 may define the boundaries of the wear track 124 as indicated by the dashed lines in FIG. 1. As also shown in FIG. 1, the wear track 124 (i.e., the portion of the shroud 10 which the blades 100 contact) may include only a portion of the abradable coating 14 such that at least one non-abraded portion 126 of the abradable coating 14 positioned outside the boundaries of the wear track 124 may remain unworn. As described further below, the abradable coating 14 may further include first regions 16 corralling second regions 18, such that the blade track 124 extends across the first and second regions 16, 18 (e.g., across a plurality of first and second regions 16, 18).

In some embodiments, the thickness of the abradable coating 14 (i.e., the first and second regions 16, 18), as measured from the outer-most surface of the coating system 20 to the flowpath surface 30 may be within the range of about 1/10 millimeter and about 2 millimeters, and more preferably within the range of about ⅕ millimeters and about 1 and ½ millimeters. In some such embodiments, the abradable coating 14 (i.e., the first and second regions 16, 18) may be initially manufactured thicker than as described above, and machined or otherwise treated to achieve the thicknesses described above. For example, after forming or manufacturing the abradable coating 14 with the first and second regions 16, 18, the abradable coating 14 may be machined, polished, or otherwise treated by removing material from the abradable coating 14 so as to provide a desired clearance between the blade tips 122 and the flowpath surface 30. The treating of the abradable coating 14 from the as-manufactured condition to create the desired flowpath surface 30 may reduce the thickness of the abradable coating 14. In some embodiments, the flowpath surface 30 may be substantially smooth. In some embodiments, the flowpath surface 30 may include some curvature in the circumferential and/or axial directions. As another example, the substrate 12 may include curvature, and the curvature of the flowpath surface 30 may substantially conform to that of the substrate 12.

With reference to FIG. 2, the abradable coating 14 may include first regions 16 and second regions 18. In some embodiments, the second regions 18 may be more intrinsically abradable than the first regions 16. For example, an exemplary abradable shroud coating including only the material of the second regions 18 may be more easily abraded by tips of rotating turbine blades or a turbine as compared to a substantially identical exemplary abradable shroud coating that includes the material of the first regions 16 in place of the material of the second regions 18. The first regions 16 may be a patterned structure or scaffold of relatively dense ridges or relative “high” portions that provide mechanical integrity while supporting blade tip 122 incursion without undue blade wear. The second regions 18 may include a highly friable microstructure that readily abrades in response to blade incursion while having relatively poor mechanical integrity as a stand-alone structure as compared to the first regions or scaffold 16. The highly friable microstructure of the second regions 18 can be achieved, for example, using a relatively porous and/or microcracked microstructure as compared to the first regions 16. As shown in FIG. 2, the second regions 18 may be corralled by the relatively dense scaffold or first regions 16 so as to facilitate blade incursion while remaining substantially intact during typical turbine operation, including operation under typical erosive, gas loading and dynamic conditions. In some embodiments, the first and second regions 16, 18 of the abradable coating 14 may together form a continuous, substantially smooth flowpath surface 30. The first and second regions 16, 18 of the abradable coating 14 may thereby form a thermo-mechanically robust abradable structure that balances the apparently contradictory requirements of high flowpath solidity, low blade tip wear, and high durability.

In some embodiments, the second regions 18 may be less dense than the first regions 16. For example, in some embodiment the second regions 18 may include about 20% to about 65% porosity, while the first regions 16 may include less than about 20% porosity. More preferably, in some embodiments the second regions 18 may include about 25% to about 50% porosity, while the first regions 16 may include less than about 15% porosity. In some embodiments, both the first and second regions 16, 18 of the abradable coating 14 may be capable of withstanding temperatures of at least about 1150 degrees Celsius, and more preferably at least about 1300 degrees Celsius.

In some embodiments, the method of manufacturing the second regions 18 of the abradable coating 14 may include use of one or more fugitive filler material to define the volume fraction, size, shape, orientation, and spatial distribution of the porosity. In some such embodiments, the filler material may include fugitive materials and/or pore inducers, such as but not limited to polystyrene, polyethylene, polyester, nylon, latex, walnut shells, inorganic salts, graphite, and combinations thereof. The filler material of the second regions 18 may act to decrease the in-use density of the second material. In some embodiments, at least a portion of the filler material of the second regions 18 may be evaporated, pyrolized, dissolved, leached, or otherwise removed from the second regions 18 during the manufacturing process (such as subsequent heat treatments or chemical treatments or mechanical treatments) or during use of the shroud 10. In some embodiments, the method of manufacturing the second regions 18 of the abradable coating 14 may include use of one or more sintering aids, such as to form lightly sintered powder agglomerates.

In some embodiments, the first and second regions 16, 18 of the abradable coating 14 may include substantially the same composition or material. For example, the first and second regions 16, 18 of the abradable coating 14 may both substantially include stabilized zirconia (such as with metallic substrates) or rare earth silicates (such as with ceramic substrates). In some embodiments, both the first and second regions 16, 18 of the abradable coating 14 may substantially include stabilized zirconia, and the substrate 12 of the shroud 10 may be nickel-based and/or cobalt-based. In some embodiments, both the first and second regions 16, 18 of the abradable coating 14 may substantially include rare earth silicates, and the substrate 12 of the shroud 10 may be SiC-based and/or Mo—Si—B-based. In some other embodiments, the composition or material of the first and second regions 16, 18 may substantially differ. In some embodiments, at least one of the first and second regions 16, 18 may substantially include, or be formed of, one or more materials of the underlying coating system 20 (e.g., an EBC/TBC and/or bond coat containing coating system 20).

As shown in FIG. 2, the second regions 18 may be substantially corralled by the first regions or scaffold 16 (i.e., positioned in-between or within the pattern of the scaffold 16). The first and second regions 16, 18 may be arranged or configured such that the passing turbine blades pass over and potentially rub into the flowpath surface 30, thereby removing both the first and second regions 16, 18 of the abradable coating 14 of the shrouds 10. In this way, the first regions or scaffold 16 may provide mechanical integrity to protect the substantially friable second regions 18 from being damaged during operation by, for example, erosion, while supporting blade tip 122 incursion without undue blade wear. The first and second regions 16, 18 of the abradable coating 14 of the shroud 10 may be arranged in any pattern, arrangement, orientation or the like such that the second regions 18 are positioned between (i.e., corralled by) the first regions 16, as illustrated in FIG. 2. In some embodiments, the first and second regions 16, 18 of the abradable coating 14 of the shroud 10 may be arranged such that the denser first regions 16 effectively shield the more friable second regions 18 from erosive flux.

In some exemplary embodiments, the first regions 16 of the abradable coating 14 of the shroud 10 may include or be defined by ridges extending from the coating system 20 to the flowpath surface 30. For example, as shown in the exemplary illustrative embodiment of FIG. 2, the first regions 16 of the abradable coating 14 may include periodic ridges that extend from the coating system 20. In some embodiments, adjacent ridges of the first regions 16 of the abradable coating 14 may be isolated from each other. In some other embodiments, as is illustrated in FIG. 2, adjacent ridges of the first regions 16 of the abradable coating 14 may be contiguous via their bases. In some embodiments, the ridges (and/or other portions of the first regions 16) may extend along a direction at least generally perpendicular to the direction of the passing turbine blades. In some embodiments, the first regions 16 of the abradable coating 14 may extend along a path or shape that substantially matches the camberline of the turbine blades. In some embodiments, the first region 16 of the abradable coating 14 comprises a set of substantially periodically spaced ridges arranged such that the direction of translation of the periodic ridges is substantially parallel to the blade passing direction. In some alternative embodiments, the ridges of the first region 16 may have portions that are non-parallel to each other, comprising patterned ridge architectures such as parallelograms, hexagons, circles, ellipses, or other open or closed shapes. In some embodiments, each first region or ridge 16 of the abradable coating 14 is substantially equidistant from its adjacent first region or ridges 16. In some alternative embodiments, one or more first region or ridge 16 of the abradable coating 14 may be variably spaced from its adjacent first region or ridge 16.

In some embodiments, at least one of the first and second regions 16, 18 of the abradable coating 14 of the shroud 10 may extend linearly, non-linearly (e.g., may include one or more curves, bends, or angles), may or may not intersect with each other, may form a regular or irregular pattern, or consist of combinations thereof or any other arrangement, pattern or orientation such that—during incursions—the turbine blades pass through the first and second regions 16, 18 of the abradable coating 14 and the first regions 16 corral the second regions 18 (i.e., the second regions 18 are positioned between the first regions 16).

In the exemplary embodiment shown in FIG. 2, the first regions 16 include relatively thick ridges such that the thickness-averaged ridge solidity is about 30%. In some embodiments, the first regions 16 may extend over the coating system 20, and the second regions 18 may extend substantially over valleys or relatively thin portions of the first regions 16, as shown in FIG. 2. In this way, the second regions 18 may fill valleys of the first regions 16. In some other embodiments (not shown), the first regions 16 and the second regions 18 may extend from the coating system 20 to the flowpath surface 30.

In some embodiments, the center-to-center distance between adjacent ridges of the first regions 16 may be within the range of about 1 millimeter and 6 millimeters, and more preferably within the range of about 2 millimeters and 5 millimeters. In some embodiments, the solidity of first regions 16, defined as the fraction of the total surface area of the flowpath surface 30 comprised of first regions 16, may be within the range from about 2% to about 50%, and more preferably may be within the range from about 5% to about 20%.

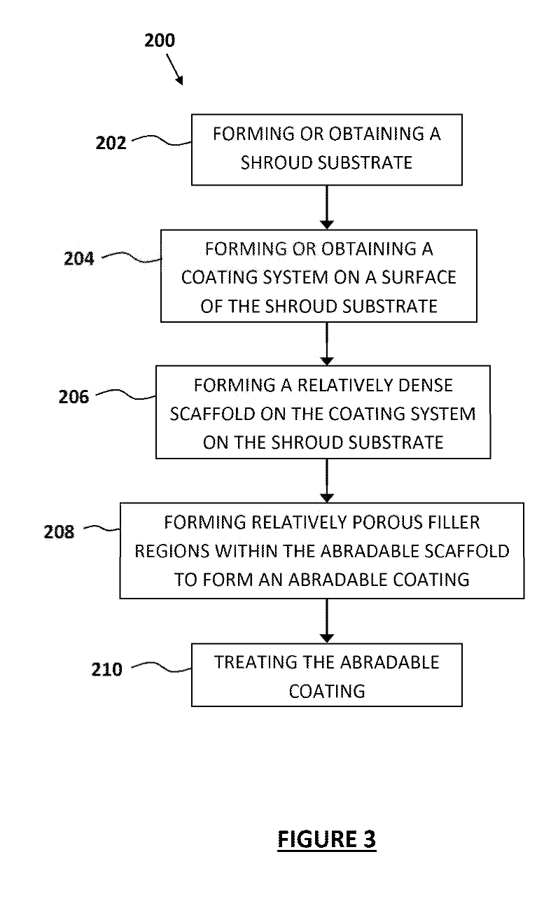

FIGS. 3-5 include flowcharts depicting exemplary methods 200, 300 and 400 of manufacturing a shroud with an abradable coating. In some embodiments, the methods 200, 300 and 400 of manufacturing a shroud with an abradable coating may include one or more of the shrouds 10 and abradable coatings 14 described above in FIGS. 1 and 2 (including variations or alternative embodiments thereof). As such, FIGS. 1 and 2 and all of the description or disclosure herein with respect to the shrouds 10 and the abradable coatings 14, and related aspects, coatings, layers, features, dimensions, functions, arrangements and the like thereof (and alternative embodiments, equivalents and modifications thereof) equally applies to the exemplary methods 200, 300 and 400 of manufacturing a shroud with an abradable coating of FIGS. 3-5 and may not be specifically discussed herein. In some embodiments, the exemplary methods 200, 300 and 400 of manufacturing a shroud with an abradable coating of FIGS. 3-5 may be utilized to manufacture one or more shroud 10 with an abradable coating 14 with one or more aspect different than as discussed above with respect to FIGS. 1 and 2.

As shown in FIG. 3, an exemplary method 200 of manufacturing a shroud with an abradable coating may include forming or obtaining 202 a shroud substrate. For example, an exemplary method 200 of manufacturing a shroud with an abradable coating may include forming or obtaining 202 at least one of the exemplary shroud substrates 12 discussed above. In other embodiments, a shroud substrate other than, or different from, the exemplary shroud substrates 12 discussed above may be obtained or formed 202. In some embodiments, forming 202 a shroud substrate may include manufacturing or forming the shroud substrate 12, at least in part. In some embodiments, the shroud substrate may be ceramic, metallic, or a combination thereof (as discussed above).

As shown in FIG. 3, an exemplary method 200 of manufacturing a shroud with an abradable coating may include forming or obtaining 204 a coating system on a surface of the shroud substrate 12. For example, an exemplary method 200 of manufacturing a shroud with an abradable coating may include forming or obtaining 204 one of the coating systems 20 discussed above. In other embodiments, an exemplary method 200 of manufacturing a shroud with an abradable coating may include forming or obtaining 204 a coating system other than, or different from, the coating systems 20 discussed above.

In some embodiments, forming or obtaining 204 a coating system on a surface of the shroud substrate may include forming or obtaining a shroud substrate containing or including a coating system on a surface thereof. In some embodiments, forming or obtaining 204 a coating system on a surface of the shroud substrate may include forming or obtaining a TBC coating on at least one surface of the shroud substrate, such as with a metallic shroud substrate (as discussed above). In some such embodiments, forming or obtaining 204 a coating system on a surface of the shroud substrate may include forming or obtaining a zirconia-based TBC coating on a surface of a metallic shroud substrate. In some other embodiments, forming or obtaining 204 a coating system on a surface of the shroud substrate may include forming or obtaining an EBC coating on at least one surface of the shroud substrate, such as with a ceramic shroud substrate. In some such embodiments, forming or obtaining 204 a coating system on a surface of the shroud substrate may include forming or obtaining a silicate-based EBC coating on a surface of a ceramic shroud substrate.

In some exemplary embodiments, forming or obtaining 204 a coating system on an outer surface of the shroud substrate may include applying the coating system to at least a portion of an outer surface of the substrate. In some such exemplary embodiments, applying the coating system to the substrate may include spraying, rolling, printing or otherwise mechanically and/or physically applying the coating system over at least a portion of a surface of the substrate. In some embodiments, forming or obtaining 204 a coating system on an outer surface of the shroud substrate may include treating as-applied coating system material to cure, dry, diffuse, sinter or otherwise sufficiently bond or couple the coating system to the substrate.

As shown in FIG. 3, an exemplary method 200 of manufacturing a shroud with an abradable coating may include forming 206 a relatively dense abradable scaffold on at least a portion of the shroud substrate, such as over the coating system 20 described above. For example, an exemplary method 200 of manufacturing a shroud with an abradable coating may include forming 206 the relatively dense abradable scaffolds or first regions 16 discussed above with respect to FIGS. 1 and 2.

In some embodiments forming 206 a relatively dense abradable scaffold on at least a portion of the shroud substrate, such as over a coating system on the shroud substrate, includes forming a relatively dense, strong patterned structure that provides mechanical integrity to the abradable coating while having sufficiently low solidity so as to support blade tip incursion with minimal blade wear, as discussed above. In some embodiments, as shown in FIG. 3, forming 206 a relatively dense abradable scaffold on at least a portion of the shroud substrate, such as over a coating system on the substrate, may be performed before forming 208 relatively porous friable filler regions that readily abrade in response to blade incursion within the scaffold to form a flowpath surface.

In some embodiments, forming 206 a relatively dense abradable scaffold on at least a portion of the shroud substrate, such as over a coating system on the shroud substrate, may include at least one additive manufacturing method or technique. For example, in some embodiments, forming 206 a relatively dense abradable scaffold on at least a portion of the shroud substrate, such as over a coating system on the shroud substrate, may include thermally spraying the relatively dense abradable material of the scaffold (e.g., the materials of the first region 16 discussed above) through a patterned mask to form the scaffold pattern or structure (e.g., the ridges or first regions 16 discussed above). As another example, in some exemplary embodiments forming 206 a relatively dense abradable scaffold on at least a portion of the shroud substrate, such as over a coating system on the shroud substrate, may include direct-write thermal spraying the relatively dense abradable material in the form of scaffold. In some such embodiments, the direct-write thermal spraying may include utilizing a small-footprint gun and dynamic aperture to form the scaffold. As yet another example, in some exemplary embodiments forming 206 a relatively dense abradable scaffold on at least a portion of the shroud substrate, such as over a coating system on the shroud substrate, may include dispensing a slurry paste in the form of a green scaffold pattern on the coating system, followed by heat treating the slurry paste so as to sinter it and form the relatively dense scaffold.

In some exemplary embodiments, forming 206 a relatively dense abradable scaffold on at least a portion of the shroud substrate, such as over a coating system on the shroud substrate, may include applying a continuous blanket layer of relatively dense abradable material, followed by removal of portions of the blanket layer to selectively define the scaffold or pattern of the relatively dense abradable material. In some such embodiments, removal of portions of the blanket layer to selectively define the scaffold or pattern may include machining portions of the blanket layer. In some such embodiments, machining portions of the blanket layer to selectively define the scaffold or pattern may be performed utilizing a mill, water jet, laser, abrasive grit blaster, or combinations thereof to remove portions of the blanket layer of relatively dense abradable material.

In some exemplary embodiments, forming 206 a relatively dense abradable scaffold on at least a portion of the shroud substrate, such as over a coating system on the shroud substrate, may include screen printing, slurry spraying or patterned tape-casting ceramic powder with binder and, potentially, one or more sintering aid, so as to form a green scaffold or pattern which, upon sintering, forms a relatively dense abradable material (e.g., the materials of the first regions 16 discussed above).

As shown in FIG. 3, an exemplary method 200 of manufacturing a shroud with an abradable coating may include forming 208 relatively porous friable filler regions between the dense abradable scaffold so as to form a smooth flowpath surface. In some embodiments, the forming 208 relatively porous friable filler regions in-between the dense abradable scaffold so as to form a smooth flowpath surface may include back-filling, depositing or otherwise applying relatively porous friable filler regions (e.g., the materials of the second regions 18 discussed above) in-between the relatively dense abradable scaffold.

In some embodiments, forming or obtaining 208 relatively porous friable filler regions in-between the dense abradable scaffold so as to form a smooth flowpath surface may include applying relatively porous friable filler material by thermal spray (with or without a mask) in-between the relatively dense abradable scaffold or pattern. In some embodiments, the relatively porous friable filler material may be ceramic powder having the composition of the first regions 16 discussed above. In some such embodiments, the ceramic powder may include at least one additive, such as a fugitive filler material, pore inducer, and/or sintering aid (as discussed above), such that the at least one additive is co-deposited, such as via thermal spray, with the ceramic powder.

In some embodiments, forming 208 relatively porous friable filler regions in-between the dense abradable scaffold so as to form a smooth flowpath surface may include applying relatively porous friable filler material as a slurry. In some such embodiments, the slurry formulation may be a ceramic slurry formulation and include at least one additive, such as a fugitive filler material, pore inducer, and/or sintering aid (as discussed above), such that the at least one additive is co-deposited with the ceramic slurry formulation. In some such embodiments, forming 208 relatively porous friable filler regions in-between the dense abradable scaffold so as to form a smooth flowpath surface may include applying a relatively porous friable filler by tape-casting or screen printing. In some such embodiments, the particle size distribution of the particles of the slurry is selected to provide a highly porous microstructure having coarse particles partially sintered at contact points. In some embodiments, forming 208 relatively porous friable filler regions in-between the dense abradable scaffold so as to form a smooth flowpath surface may include sintering the filler material. In some embodiments, forming 208 relatively porous friable filler regions in-between the dense abradable scaffold so as to form a smooth flowpath surface 30 may include applying relatively porous friable filler material as a slurry formulation with pre-agglomerated or pre-aggregated particles.

In some embodiments, forming 208 relatively porous friable filler regions in-between the dense abradable scaffold so as to form a smooth flowpath surface on the shroud substrate may include producing high aspect ratio tabular particles via, for example, hydrothermal synthesis, combustion synthesis, tape casting, fine extrusion, and/or combinations thereof. In some such embodiments, forming 208 relatively porous friable filler regions in-between the relatively dense abradable scaffold to form a smooth flowpath surface on the shroud substrate may include aligning the high aspect ratio tabular particles via, for example, electrophoretic deposition, slip casting, tape casting, extrusion, and/or combinations thereof.

As shown in FIG. 3, an exemplary method 200 of manufacturing a shroud with an abradable coating may include treating 210 the abradable coating, such as the relatively dense abradable scaffold and relatively porous friable filler regions. In some embodiments, treating 210 the abradable coating may include treating the flowpath surface of the abradable coating formed by the relatively dense abradable scaffold and relatively porous friable filler regions to form a substantially smooth flowpath surface, such as by leveling and/or smoothing of the as-manufactured flowpath surface. For example, in some such embodiments, treating 210 the abradable coating may include grinding, sanding, etching or otherwise removing high areas of the flowpath surface formed by the relatively dense abradable scaffold and/or relatively porous friable filler regions. In some embodiments, treating 210 the flowpath surface of the abradable coating formed by the relatively dense abradable scaffold and relatively porous friable filler regions may include an assembly grind. In some such embodiments, the assembly grind may remove prominent portions (e.g., tips) of the relatively dense abradable scaffold (e.g., ridges) or relatively porous friable filler (e.g., valleys), so as to bring the flowpath surface of the abradable coating formed by the relatively dense abradable scaffold and relatively porous friable filler regions to a substantially common height so as to achieve a substantially smooth, continuous flowpath surface. In some embodiments, treating 210 the abradable coating may include heat treating the abradable coating. In some such embodiments, heat treating 210 the abradable coating may include sintering the relatively dense abradable scaffold and/or the relatively porous friable filler regions. In some such embodiments, heat treating 210 the abradable coating may include heating the relatively dense abradable scaffold and/or the relatively porous friable filler region to burn out, evaporate or otherwise remove fugitive materials and/or pore inducers therein via the application of heat.

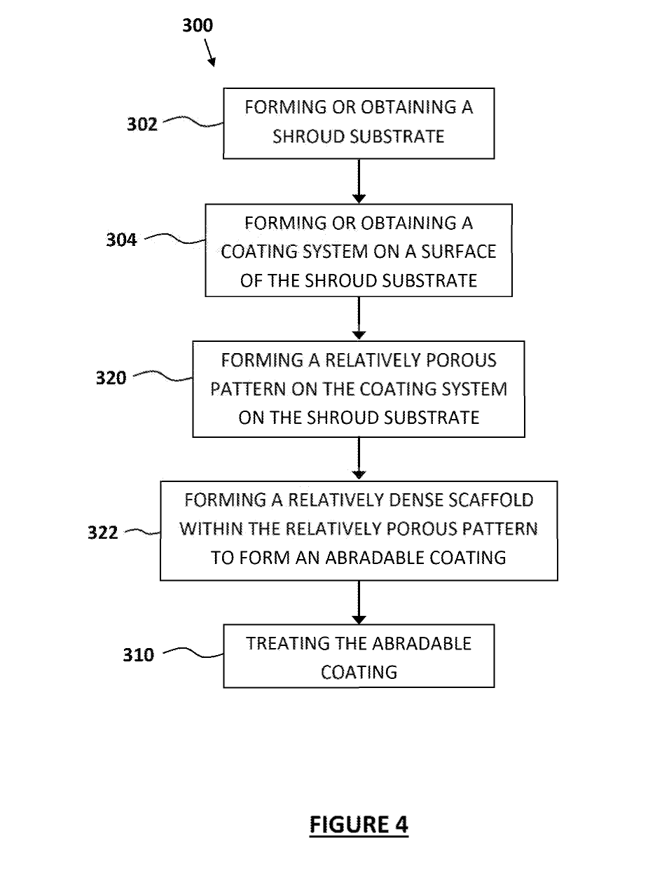

Another exemplary method of manufacturing a shroud with an abradable coating is shown in FIG. 4 and indicated generally by numeral 300. The method 300 of manufacturing a shroud with an abradable coating of FIG. 4 is similar to the method 200 of manufacturing a shroud with an abradable coating of FIG. 3, and therefore like aspects are indicated by reference numerals preceded by “3” as opposed to “2.” As shown in FIG. 4, a difference between the method 300 of manufacturing a shroud with an abradable coating of FIG. 4 and the method 200 of manufacturing a shroud with an abradable coating of FIG. 3 is the order of formation of the relatively porous friable and relatively dense scaffold portions of the abradable coating.

As shown in FIG. 4, an exemplary method 400 of manufacturing a shroud with an abradable coating may include forming 320 a relatively porous friable pattern on the shroud substrate, such as on the coating system 20. In some embodiments, forming 320 a relatively porous friable pattern (the second regions 18 described above) may include applying the relatively porous friable pattern on the substrate via a method or technique as described above with respect to the forming 206 of a relatively dense abradable scaffold of the method 200 of FIG. 3. For example, forming 320 a relatively porous friable pattern (the second regions 18 described above) may include additive manufacturing methods or techniques. Alternatively, a substantially uniform blanket layer of relatively porous friable material may be formed on the substrate and portions thereof may be removed to form the pattern. Similarly, forming 320 a relatively porous friable pattern may include applying the relatively porous friable pattern with a relatively porous friable material composition, formulation, particle configuration, characteristics or other arrangement as described above with respect to the porous friable filler regions of the forming 208 relatively porous friable filler regions in-between the dense abradable scaffold of the method 200 of FIG. 3. For example, forming 320 a relatively porous friable pattern (the second regions 18 described above) on the shroud substrate may include utilizing relatively porous friable material with at least one additive, such as filler, pore inducer and/or sintering aid, and/or the relatively porous friable material may include pre-agglomerated or pre-aggregated particles and/or substantially aligned high aspect ratio tabular particles.

As also shown in FIG. 4, an exemplary method 400 of manufacturing a shroud with an abradable coating may include forming 322 a relatively dense abradable scaffold (e.g., the first regions 16 described above) in-between the relatively porous friable pattern so as to form a substantially smooth flowpath surface 30. In some embodiments, forming 322 a relatively dense abradable scaffold (e.g., the first regions 16 described above) in-between the relatively porous friable pattern on the shroud substrate may include applying the relatively dense abradable scaffold on the substrate via a method or technique as described above with respect to the forming 208 relatively porous friable filler regions in-between the dense abradable scaffold of the method 200 of FIG. 3. For example, the forming 322 a relatively dense abradable scaffold in-between the relatively porous friable pattern on the shroud substrate may include backfilling or otherwise depositing relatively dense abradable material in-between the relatively porous friable pattern (e.g., within gaps and/or low or thin areas of the pattern). Similarly, forming 322 a relatively dense abradable scaffold (e.g., the first regions 16 described above) in-between the relatively porous friable pattern on the shroud substrate may include applying the relatively dense abradable scaffold material or structural composition, formulation, characteristic(s) or other arrangement as described above with respect to the forming 206 of a relatively dense abradable scaffold of the method 200 of FIG. 3.

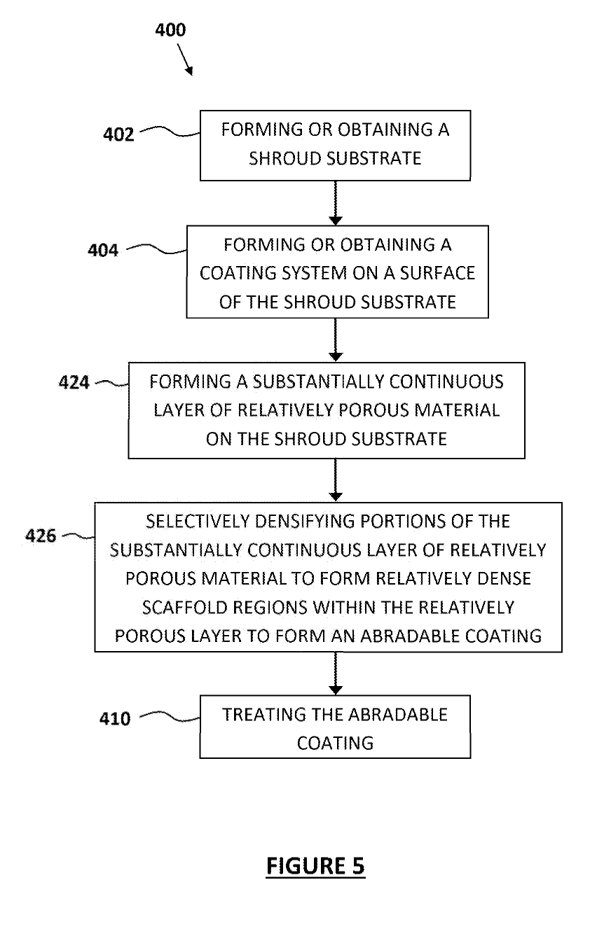

Another exemplary method of manufacturing a shroud with an abradable coating is shown in FIG. 5 and indicated generally by numeral 400. The method 400 of manufacturing a shroud with an abradable coating of FIG. 5 is similar to the methods 200 and 300 of manufacturing a shroud with an abradable coating of FIGS. 3 and 4, respectively, and therefore like aspects are indicated by reference numerals preceded by “4,” as opposed to “2” or “3.” As shown in FIG. 5, a difference between the method 400 of manufacturing a shroud with an abradable coating of FIG. 5 and the methods 200 and 300 of manufacturing a shroud with an abradable coating of FIGS. 3 and 4, respectively, is the formation of the relatively porous friable filler and relatively dense scaffold regions of the abradable coating.

As shown in FIG. 5, an exemplary method 400 of manufacturing a shroud with an abradable coating may include forming 424 a substantially continuous blanket layer of relatively porous friable material on the shroud, such as on a coating system 20, so as to form a flowpath surface 30 (e.g., a layer of the material of the second regions 18 described above). In some such embodiments, forming 424 a substantially continuous blanket layer of relatively porous friable material on the shroud may include utilizing relatively porous friable material as described above. For example, forming 424 a substantially continuous blanket layer of relatively porous friable material on the shroud may include thermally spraying relatively porous friable material that includes fugitive materials. As another example, forming 424 a substantially continuous blanket layer of relatively porous friable material on the shroud may include utilizing slurry, paste or tape formulations having fugitive materials. As yet another example, forming 424 a substantially continuous blanket layer of relatively porous friable material on the shroud may include utilizing slurry, paste or tape formulations having coarse, low-sintering particles.

As also shown in FIG. 5, an exemplary method 400 of manufacturing a shroud with an abradable coating may include selectively densifying 426 portions of the substantially continuous blanket layer of relatively porous friable material to form a relatively dense abradable scaffold within the layer (e.g., the first regions 16 discussed above). In some such embodiments, selectively densifying 426 portions of the substantially continuous blanket layer of relatively porous friable material to form a relatively dense abradable scaffold pattern within the layer may include screen-printing or otherwise introducing sintering aids into/onto the substantially continuous blanket layer of relatively porous friable material in a scaffold pattern. The substantially continuous blanket layer of relatively porous friable material, with the scaffold pattern of screen-printed sintering aids, may be subsequently sintered to form a relatively dense abradable scaffold in the relatively porous friable layer to form the abradable coating. In some other embodiments, selectively densifying 426 portions of the substantially continuous blanket layer of relatively porous friable material to form a relatively dense abradable scaffold within the layer may include selectively sintering (e.g., such as using laser beam or electron-beam localized heat sources) portions of the layer in a scaffold pattern in the relatively porous friable layer so as to form the relatively dense abradable scaffold of the abradable coating

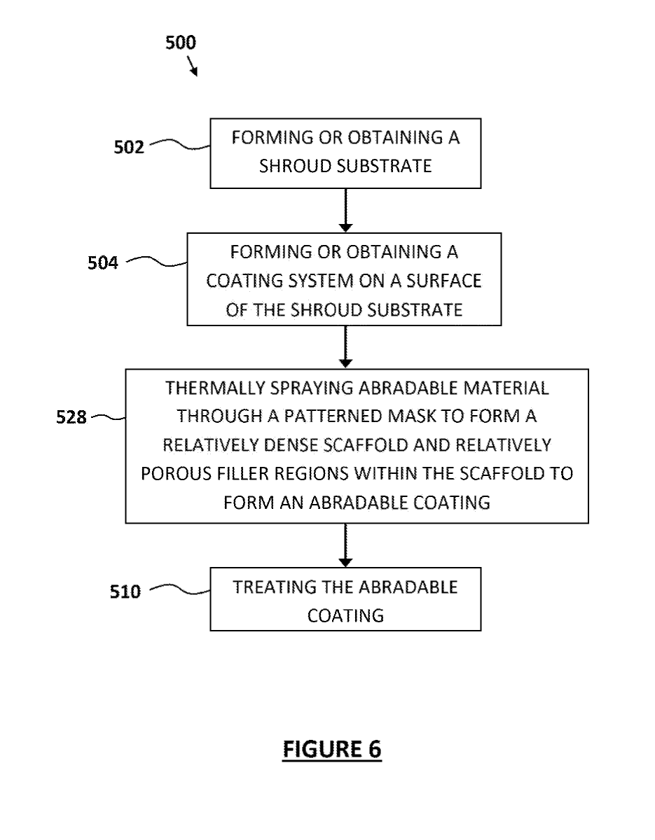

Another exemplary method of manufacturing a shroud with an abradable coating is shown in FIG. 6 and indicated generally by numeral 500. The method 500 of manufacturing a shroud with an abradable coating of FIG. 6 is similar to the methods 200, 300 and 400 of manufacturing a shroud with an abradable coating of FIGS. 3, 4 and 5, respectively, and therefore like aspects are indicated by reference numerals preceded by “5,” as opposed to “2,” “3” or “4.” As shown in FIG. 6, a difference between the method 500 of manufacturing a shroud with an abradable coating of FIG. 6 and the methods 200, 300 and 400 of manufacturing a shroud with an abradable coating of FIGS. 3, 4 and 5, respectively, is the formation of the relatively porous friable filler and relatively dense scaffold regions of the abradable coating.

As shown in FIG. 6, an exemplary method 500 of manufacturing a shroud with an abradable coating may include thermally spraying 528 an abradable material through a patterned mask to substantially concurrently or simultaneously form a relatively dense abradable scaffold and a relatively porous friable filler. In some such embodiments, thermally spraying 528 an abradable material through a patterned mask so as to form a relatively dense abradable scaffold and relatively porous friable filler regions in-between the scaffold may include simultaneously forming both structures. For example, abradable materials (as described above) may be thermally sprayed 528 through a patterned mask configured to produce the dense ridges or first regions 16 described above and spaced such that the second regions 18 discussed above are formed from overspray that is retained between the ridges or first regions 16. For example, the mask opening width, spacing between mask openings, gap between mask and surface being coated, thickness of the mask material, cross sectional shape of the openings, and combinations thereof may be configured to substantially contemporaneously form the relatively dense abradable scaffold and relatively porous friable filler regions in-between or within the scaffold. In some other embodiments, the mask could be configured with movable elements that adjust opening widths and/or standoff distance of the mask as the abradable coating thickness increases to more completely fill the relatively dense abradable scaffold with the relatively porous friable filler regions. In some embodiments, an additional slurry coating of relatively porous friable filler material may subsequently be utilized to more completely fill the relatively dense abradable scaffold with the relatively porous friable filler regions.

As shown in FIG. 6, in some embodiments the method 500 of manufacturing a shroud with an abradable coating may include treating 510 the flowpath surface. In some such embodiments, treating 510 the flowpath surface may include removing prominent portions of the abradable coating to a substantially uniform thickness, so as to obtain a substantially smooth flowpath surface.

It is to be understood that the above description is intended to be illustrative, and not restrictive. Numerous changes and modifications may be made herein by one of ordinary skill in the art without departing from the general spirit and scope of the invention as defined by the following claims and the equivalents thereof. For example, the above-described embodiments (and/or aspects thereof) may be used in combination with each other. In addition, many modifications may be made to adapt a particular situation or material to the teachings of the various embodiments without departing from their scope. While the dimensions and types of materials described herein are intended to define the parameters of the various embodiments, they are by no means limiting and are merely exemplary. Many other embodiments will be apparent to those of skill in the art upon reviewing the above description. The scope of the various embodiments should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Also, the term “operably” in conjunction with terms such as coupled, connected, joined, sealed or the like is used herein to refer to both connections resulting from separate, distinct components being directly or indirectly coupled and components being integrally formed (i.e., one-piece, integral or monolithic). Further, the limitations of the following claims are not written in means-plus-function format and are not intended to be interpreted based on 35 U.S.C. §112, sixth paragraph, unless and until such claim limitations expressly use the phrase “means for” followed by a statement of function void of further structure. It is to be understood that not necessarily all such objects or advantages described above may be achieved in accordance with any particular embodiment. Thus, for example, those skilled in the art will recognize that the systems and techniques described herein may be embodied or carried out in a manner that achieves or optimizes one advantage or group of advantages as taught herein without necessarily achieving other objects or advantages as may be taught or suggested herein.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the disclosure may include only some of the described embodiments. Accordingly, the invention is not to be seen as limited by the foregoing description, but is only limited by the scope of the appended claims.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

We claim:

1. A method of manufacturing a turbine shroud abradable coating, comprising:
forming a relatively dense scaffold on a shroud substrate; and
forming relatively porous filler regions in-between the relatively dense scaffold to form a substantially continuous flowpath surface.

2. The method of claim 1, wherein the porosity of the relatively porous filler regions is achieved via pores and/or microcracks within the relatively porous filler regions.

3. The method of claim 1, wherein forming the relatively porous filler regions in-between the relatively dense scaffold includes applying relatively porous filler material in-between the relatively dense scaffold regions via at least one additive manufacturing method.

4. The method of claim 1, wherein the relatively porous filler regions comprise at least one of a fugitive filler, a pore inducer or a sintering aid.

5. The method of claim 1, wherein forming the relatively dense scaffold includes applying relatively dense material on the substrate via at least one additive manufacturing method to form the relatively dense scaffold.

6. The method of claim 5, wherein the at least one additive manufacturing method is thermal spraying.

7. The method of claim 1, wherein forming the relatively dense scaffold on the shroud substrate includes applying a blanket layer of relatively dense material on the substrate and selectively removing portions of the layer to form the relatively dense scaffold.

8. The method of claim 1, wherein forming the relatively dense scaffold and forming the relatively porous filler regions includes utilizing at least one material to form the scaffold and filler regions as green bodies, and wherein the method includes sintering the scaffold and filler regions.

9. The method of claim 1, wherein the material forming the scaffold and filler regions comprises substantially zirconia-based or silicate-based compositions.

10. The method of claim 1, further comprising machining the flowpath surface to form a substantially smooth flowpath surface.

11. The method of claim 1, further comprising heat treating the abradable coating.

12. A method of manufacturing a turbine shroud abradable coating, comprising:
forming a relatively porous pattern on a shroud substrate; and
forming a relatively dense scaffold in-between the relatively porous pattern to form a substantially continuous flowpath surface.

13. The method of claim 12, wherein the porosity of the relatively porous pattern comprises pores and/or microcracks within the relatively porous pattern.

14. The method of claim 12, wherein forming the relatively porous pattern includes forming a relatively porous layer on the shroud substrate and selectively removing portions of the relatively porous blanket layer, and wherein forming the relatively dense scaffold in-between the relatively porous blanket pattern includes backfilling a relatively dense scaffold material into the relatively porous pattern.

15. The method of claim 12, wherein forming the relatively porous pattern on the shroud substrate includes applying a relatively porous material in a pattern on the shroud substrate via at least one additive manufacturing method, and wherein forming the relatively dense scaffold in-between the relatively porous pattern includes backfilling a relatively dense scaffold material into the relatively porous pattern.

16. The method of claim 12, wherein the relatively porous pattern comprises at least one of a fugitive filler, a pore inducer or a sintering aid.

17. The method of claim 12, wherein the relatively dense scaffold and the relatively porous pattern comprises substantially zirconia-based or silicate-based compositions.

18. The method of claim 12, further comprising machining the flowpath surface to form a substantially smooth flowpath surface.

19. The method of claim 12, further comprising heat treating the abradable coating.

20. A method of manufacturing a turbine shroud abradable coating, comprising:
forming a substantially continuous layer of relatively porous material on a shroud substrate; and
selectively densifying portions of the substantially continuous layer of relatively porous material to form relatively dense scaffold regions within the relatively porous layer,
wherein the relatively porous regions and relatively dense regions form a substantially continuous flowpath surface.

21. The method of claim 20, wherein the porosity of the relatively porous material comprises pores and/or microcracks within the relatively porous material.

22. The method of claim 20, wherein selectively densifying portions of the substantially continuous layer of relatively porous material to form the relatively dense abradable scaffold includes introducing sintering aids into the substantially continuous layer of relatively porous material in a scaffold pattern and sintering the substantially continuous layer.

23. The method of claim 20, wherein selectively densifying portions of the substantially continuous layer of relatively porous material to form the relatively dense abradable scaffold includes selectively sintering portions of the substantially continuous layer in a scaffold pattern via laser or electron-beam sintering.

24. The method of claim 20, further comprising machining the flowpath surface to form a substantially smooth flowpath surface

25. The method of claim 20, further comprising heat treating the abradable coating.

26. A method of manufacturing a turbine shroud abradable coating, comprising:
thermally spraying an abradable material through a patterned mask onto a shroud substrate to substantially concurrently form:
a relatively dense abradable scaffold; and
relatively porous filler regions in-between the relatively dense scaffold,
wherein the scaffold and filler regions form a substantially continuous flowpath surface.

27. The method of claim 26, wherein the patterned mask is configured such that the relatively dense abradable scaffold is formed opposite the mask openings and the relatively porous filler regions are formed from overspray of the abradable material in-between the mask openings.

28. The method of claim 26, comprising adjusting a size of openings of the patterned mask and/or a standoff distance of the patterned mask from the shroud substrate after a portion of the relatively dense abradable scaffold and relatively porous filler regions are formed.

29. The method of claim 26, further comprising backfilling relatively porous filler material on the relatively porous filler regions in-between the relatively dense scaffold region.

30. The method of claim 26, wherein the abradable material comprises substantially zirconia-based or silicate-based compositions.

31. The method of claim 26, further comprising machining the flowpath surface to form a substantially smooth flowpath surface.

32. The method of claim 26, further comprising heat treating the abradable coating.
